(19) United States
(12) Patent Application Publication
(10) Pub. No.: US 2006/0034978 A1
(43) Pub. Date: Feb. 16, 2006

(54) Aerosol compositions, devices and methods

(75) Inventors: Gary Deem, DanVille, IL (US); Don Sheppard, Danville, IL (US); Greg Sheppard, Bismark, IL (US)

Correspondence Address: BANNER & WITCOFF, LTD., TEN SOUTH WACKER DRIVE, SUITE 3000, CHICAGO, IL, 60606, US

(73) Assignee: Grain Processing Corporation, Muscatine, IA (US)

(21) Appl. No.: 10/918,895

(22) Filed: Aug. 16, 2004

(51) Int. Cl. A23L 1/00

(52) U.S. Cl. 426/116

(57) ABSTRACT

Disclosed is an aerosol composition that includes water, an organic propellant, molasses components, and a surfactant. The composition preferably further includes an anti-agglomeration agent to inhibit agglomeration of insoluble materials and a sugar stabilizer to inhibit crystallization of sugar in the composition. Also disclosed are methods for feeding an animal by dispensing an aqueous solution of a sugar from an aerosol device, preferably an aerosol device that includes an aerosol composition as described above.

### FIELD OF THE INVENTION

The invention is in the field of animal feeds. In particular, the invention relates to aerosol compositions, devices, and methods that may be employed to improve the flavor or palatability of an animal feed or to provide additional calories or other nutritive benefit.

### BACKGROUND OF THE INVENTION

It is often desirable to add flavorants to animal feed to increase palatability of the feed and to add nutritional value. Flavorants often are added by spraying additives onto the feed prior to or at the same time as feeding. For example, a flavorant may be sprayed onto hay in a feeding trough to enrich the flavor of the hay and to render the hay more palatable to cattle. It is recognized that the addition of a flavorant can cause the cattle to consume additional hay, which may be advantageous for more rapid weight gain or prolific milk production.

Molasses is well regarded as a flavorant for animal feeds. Molasses confers many benefits, including increased palatability, improved aroma, higher feed intake, and extra energy. Molasses also can act as a dust suppressant, which provides advantages for certain types of feeds.

Despite these advantages, it can be difficult as a practical matter to employ molasses as a feed additive. In applying a feed additive to an animal feed, it is desirable to spray the additive in liquid form onto the feed. It can be very difficult to apply molasses in a uniform, homogeneous manner, in light of the high solids content and high viscosity associated with conventional molasses formulations. Such high-viscosity liquids do not pass readily through nozzles or other orifices of small diameter, thus making it difficult to use conventional spraying equipment. Molasses is sometimes sprayed from manually actuated pump bottles, but the molasses liquid typically will quickly form clogs and large liquid droplets, thus making uniform application very difficult.

Molasses may be diluted with water to a lower solids content and viscosity, but such dilution is not a satisfactory solution. When the molasses is diluted to a solids content of less than about 50%, molds may grow in the solution. Further, it is difficult to dilute molasses homogenously in light of the high viscosity of the molasses solution, because “clumps” of high viscosity regions of liquid may remain. Moreover, even homogenously diluted molasses has a sufficiently high viscosity and solids content such that the diluted compositions are not easily sprayed through fine diameter nozzles. In light of these drawbacks, spray line equipment used in the feed lot industry allows molasses to be included in a spray-on formulation in a typical maximum amount of only about 3% by weight.

The prior art has proposed a number of solutions to the problem of spraying molasses. For instance, U.S. Publication No. 2002/0068118 purports to disclose a method of distributing molasses onto hay. As purportedly taught by this reference, molasses is simultaneously sprayed with a fog of fine water droplets. This method is somewhat cumbersome and is not deemed suitable for large scale applications

A more ideal molasses application method would involve spraying molasses from an aerosol device. Aerosol devices are typically small, highly portable, and inexpensive, and allow precise control of the amount of contents dispensed and precise designation of the target area to which the contents are applied.

There are, however, numerous difficulties apparent in attempting to spray molasses from an aerosol device. A principal difficulty is that molasses has a very high viscosity, which renders molasses difficult to dispense through a small orifice. In addition, molasses is essentially an aqueous solution of sucrose and other materials with some suspended insoluble components. For various practical reasons, it is desired to use an organic propellant in the aerosol device, and such organic propellants generally are incompatible with the aqueous molasses. Moreover, the insoluble components may render it difficult to spray molasses from the aerosol can. Also, the sugar in the molasses solution may tend to crystallize, thereby causing separation of the mixture inside the aerosol device and causing various clogging problems.

The invention seeks in preferred embodiments to provide an aerosol device that contains an aqueous solution of sugar which is contemplated to include sucrose and other sugars and that is suitable for dispensing the aqueous solution. In other embodiments, not mutually exclusive with the aforesaid preferred embodiments, the invention seeks to provide a method for feeding an animal.

### THE INVENTION

It has now been discovered that aqueous solutions that include soluble and insoluble molasses components may be dispensed through an aerosol device. The invention contemplates in one embodiment an aqueous aerosol composition that includes water; at least one organic aerosol propellant, typically a lower-order hydrocarbon; a sugar, by which is contemplated any mono-, di-, or tri-glyceride; and a surfactant, the surfactant being effective to provide a viscosity for the aqueous phase of the composition that is sufficiently low to allow the composition to be uniformly dispensed from an aerosol device. The composition preferably includes a sugar stabilizer in an amount effective to inhibit crystallization of the sugar. The composition most preferably includes molasses components, to which at least a portion of the sugar in the composition is attributed (although additional sugar may be added). In highly preferred embodiments, the composition includes a flavoring additive, such as caramel flavor.

The invention further contemplates an aerosol device that contains a composition as heretofore described. The device is preferably a sealed container that includes a valve that is in fluidic communication with the container, the valve allowing the release of a portion of the contents of the container upon actuation. The valve is also in fluidic communication with a nozzle that allows the material dispensed from the container to be dispersed. Preferably, the valve is a manually actuated valve that allows for unmetered release of the contents of the pressurized container.

The above-described composition and device may be used to apply molasses components onto nutritive sources, which can include both animal feeds for non-human animals and human food products. Also encompassed by the invention is a method for feeding a non-human animal by providing an aerosol device having disposed therein an aerosol composition that contains a sugar (which may be derived in whole or part from molasses); dispensing at least a portion of the contents of the aerosol device onto an animal feed, and feeding the animal feed to an animal.

### BRIEF DESCRIPTION OF THE DRAWINGS

FIG. 1 is a perspective view of an aerosol device useful in accordance with some embodiments of the present invention.

FIG. 2 is a cross-sectional view taken along line 2-2 in FIG. 1.

FIG. 3 is a front elevation of the nozzle of the aerosol device shown in FIGS. 1 and 2.

FIG. 4 is side elevation of the nozzle of the aerosol device shown in FIGS. 1 and 2.

FIG. 5 is a rear elevation of the nozzle of the aerosol device shown in FIGS. 1 and 2.

### DETAILED DESCRIPTION OF THE PREFERRED EMBODIMENTS

The invention provides an aerosol composition that includes water, a propellant, and a sugar. The propellant used in conjunction with the invention should be an organic propellant, and most preferably, an aliphatic hydrocarbon propellant. By “hydrocarbon” is contemplated any propellant composed of carbon and hydrogen. The propellant is preferably an alkane that contains three to five carbon atoms, such as propane, n-butane, iso-butane, n-pentane, iso-pentane, and so forth. Other suitable propellants include alkenes such as isobutene. It is contemplated that other organic propellants, such as propellants of the chlorofluorocarbon or fluorocarbon type, in particular propellant such as 1,1,1,2-tetrafluoroethane, 1,1,1,2,3,3,3-heptafluoropropane, and the like, may be suitable for use in conjunction with the invention. The composition may contain mixtures of the foregoing, or additional propellants (e.g. dimethyl ether). The preferred propellant is “A-70,” sold by Aeropres of Shreveport, La., this propellant comprising a mixture of isobutane, propane and butane.

The propellant may be present in the composition in any suitable amount. Generally, the propellant should be present in at least an amount sufficient to dispense the remaining ingredients in the composition from an aerosol device when used at normal atmospheric pressures. In preferred embodiments of the invention, the propellant is present in the composition in an amount ranging from 12 to 18% by weight, based on the total composition including water.

The composition preferably includes at least one flavoring agent, which may be any natural or artificial ingredient designed to add flavor and/or increase palatability of the aerosol product once dispensed. When used in conjunction with an animal feed for ruminants, horses, or the like, the flavor may be, for instance, cherry, apple, bacon, caramel, or licorice flavoring. More generally, any suitable flavoring may be used in addition to or in lieu of the foregoing. The flavoring may be present in any amount effective to impart flavor to the composition.

In accordance with the various embodiments of the invention, the aerosol composition includes at least one sugar, by which is contemplated any mono-, di-, or tri-glyceride or mixtures thereof. Other carbohydrates having a higher molecular weight may be included but are not deemed to be sugars within the purview of the present invention. The sugar is preferably sucrose, but other sugars such as glucose, fructose, lactose, galactose, and the like may be included. For instance, at least some sugars other than sucrose often are present in molasses, and in some embodiments of the invention, other sugars may be added or used in lieu of the sugar derived from molasses. It is contemplated that partially converted corn sugars (such as high-fructose corn syrup) may be used in some embodiments in addition to or in lieu of molasses. The sugar should be present in an amount sufficient to impart detectable sweetness to the aerosol composition once dispensed. The sugar is preferably present in an amount of at least 9% by total weight (including water and propellant). Preferably, the sugar is present in an amount ranging from 10 to 12% by total weight (including water and propellant), although the actual amount of sugar will vary in practice.

The sugar is preferably provided in conjunction with other molasses components, although it should be understood that the composition may include additional sugar added to sugar that is derived from molasses. The term “molasses” is used in the art to signify (1) a sugary extract of a sugar-containing plant, in particular sugar cane (the molasses being sometimes designated as “high-test” molasses; (2) the sugar-containing residue after one or more sugar crystallizations from an extract of a sugar-containing plant (such as blackstrap molasses or commercial molasses grades “A,” “B,” or “C”), such molasses typically being a solution having 65 to 84° Brix with at least 48% total sugar and being partially converted; or (3) a converted plant residue, in particular wood molasses. Wood molasses is typically derived either by solublizing wood sugars (wood hemicelluloses) or by hydrolyzing cellulose with acid to form glucose. Any of the foregoing types of molasses may be used in conjunction with the invention. Examples of molasses suitable for use in conjunction with the invention includes citrus molasses, sorghum molasses, wood molasses, sugar beet molasses, sugar cane molasses, and the like. Sugar beet molasses and sugar cane molasses are deemed particularly suitable for use in conjunction with the invention. A highly preferred molasses is sugar beet or cane molasses at 79.5° Brix, having a sugar content of 43%.

Molasses typically includes some components that are not soluble in water and in the water/propellant mixture inside an aerosol device, such components including solids, oils, and possibly other insoluble materials. Moreover, molasses is a naturally derived material, and accordingly it is not possible in practice to know the precise compositional make-up of the molasses. For these reasons, and in light of the heretofore described difficulties of dispensing a sugary solution from a nozzle, additional ingredients are typically incorporated into the aerosol composition. To render an aqueous solution that includes molasses components suitable for dispensing from an aerosol device, it has been found desirable to stabilize the sugar so as to inhibit sugar crystallization in the aerosol device and in the valve and nozzle upon dispensing. It is often desirable to add ingredients to render more miscible the propellant and water in the aerosol device. Agglomeration of the insoluble components of molasses inside the aerosol device should be at least substantially inhibited. Further, the aerosol composition should be not only edible but also innately palatable, particularly when the aerosol composition is intended to be used to enhance the palatability of an animal feed.

A sugar stabilizer is desirably included in the aerosol composition. The sugar stabilizer should be present in an amount effective to inhibit crystallization of the sugar inside an aerosol device that contains the aerosol composition and in the valve and nozzle of the aerosol device. Preferred sugar stabilizers are contemplated to include lower order sugar alcohols (e.g. sorbitol) and C₃-C₅ polyols. While it is contemplated that other C₃-C₅ alcohols may be used, the preferred C₃-C₅ alcohols are propylene glycol and glycerol, which are excellent stability agents and which impart body to the formulation. The C₃-C₅ polyol should be edible and non-toxic and should not be unpalatable in the amounts used. In preferred embodiments, the sugar stabilizer is present in an amount ranging from 20 to 25%, by total weight of the composition (including water and propellant).

As heretofore discussed, the water in the composition and the organic propellant may be somewhat incompatible in the aerosol device. Generally, the organic propellant will be in a liquid phase at the pressures used inside the aerosol device (typically around 70 psig). To enhance miscibility between the organic phase and the aqueous phase, the composition preferably includes a surfactant. Ideally, the surfactant renders the aqueous and organic materials in the aerosol composition sufficiently miscible to provide for a single liquid phase inside the aerosol device, although this is not necessary. Preferred surfactants are fatty acid esters. The most highly preferred surfactants are C₈-C₁₀ esters of C₂-C₅ alcohols, such as propylene glycol, with the most highly preferred surfactant being a mixture of capric and caprylic acid esters of propylene glycol. The surfactant is preferably employed in an amount ranging from 4 to 5% by total weight. It is contemplated that other surfactants also may be deemed suitable for use in conjunction with the invention.

It has been found that the surfactant serves both to make the liquid and organic phases more compatible with one another and to lower the viscosity of the aqueous phase of the composition relative to the viscosity of such phase in the absence of the surfactant. To the extent that the organic propellant is included in a single phase with the water and water-soluble materials, that phase is deemed an “aqueous phase,” i.e., the “aqueous phase” should be deemed to include the phase in the composition that includes water, irrespective of whether the phase also includes the organic propellant. The surfactant should be present in an amount effective to allow the mixture to be dispensed uniformly from an aerosol device, by which is contemplated that clogging and formation of large droplets after several seconds of continuous spraying are substantially or completely avoided. The amount of surfactant employed in a given composition will be expected to vary with the amounts and makeup of the other components of the composition and possibly with the nature of the container valve and nozzle of the aerosol device. Generally the HLB value (hydrophilic/lyophilic balance value) for the surfactant should be such as to render the surfactants suitable for use in conjunction with the invention. The hereinbefore described mixtures of capric and caprylic acid esters of propylene glycol have an HLB value of about 2-3.

A lecithin is preferably employed as an anti-agglomeration agent. The lecithin, which is preferably a soy lecithin, is used in any amount effective to inhibit agglomeration of insoluble components of the aerosol composition. Preferably, the lecithin is present in an amount ranging from 9 to 11% by total weight. Lecithin is believed to form a coating around insoluble particles or oleogenic droplets inside the aerosol device and to thereby inhibit agglomeration of such materials. To the extent that the lecithin functions as a surfactant in the composition, the combined HLB value of the lecithin and caprylic/capric acid esters of propylene glycol is in the range of 6-7.

The composition may include any other materials that are deemed consistent for use with the intended application. For instance, fortifying agents that may be applied with the molasses include vitamins, (e.g. A, C, E), tocopherols, minerals (for example, calcium compounds), proteins, amino acids, antibiotics, hormones, direct fed microorganisms (probiotics), dewormers, organic trace minerals (chelated and complexed trace minerals), flavor compounds, beta-agonist compounds (e.g. ractopamine), prebiotic oligosaccharides (e.g. fructooligosaccharides and mannanohgosaccharides), nutraceuticals (e.g. glucosamie and chondroitinsulfate), yeast and yeast products, fat and oils, starch and maltodextrins, sweeteners, feed intake limiting compounds, and other nutrients or additives that improve the nutritional or palatable qualities of the feed. Antioxidants for these materials such as ethoxyquin (1,2-dlhydro-6-ethoxy-2,2,4-trimethyl quinoline, including synthetic and natural antioxidants), may be included. Other additives that can also be included in the composition include promazine, hydrochloride, chloromadionone acetate, oxytetracycline, and so forth. Monensin drug used to control appetite and increase feed efficiency in ruminants may be used if the composition is intended for ruminant animals. Bloat inhibitors such as polaxaline can also be employed. The quantity and concentration of these materials is preferably in accordance with established custom and usage, but generally such materials may be employed in any amounts suitable for use in connection with the intended purpose of such ingredient. Generally, to be deemed suitable for use in conjunction with the invention, any of the foregoing ingredients should be chemically compatible with the other components of the aerosol composition, and should be compatible with the packaging materials used in connection with the aerosol device (for instance, highly ionic materials may corrode the packaging and may be unsuitable). In practice, the inclusion of some of the foregoing materials will depend on whether the blending and/or packaging facilities are practicably able to incorporate such materials into the aerosol composition and device. For instance, certain blending or packaging facilities may be unauthorized to include pharmaceutical materials in a food-grade formulation. Otherwise, the selection of such additional materials is optional and may be left to the discretion of those skilled in the art.

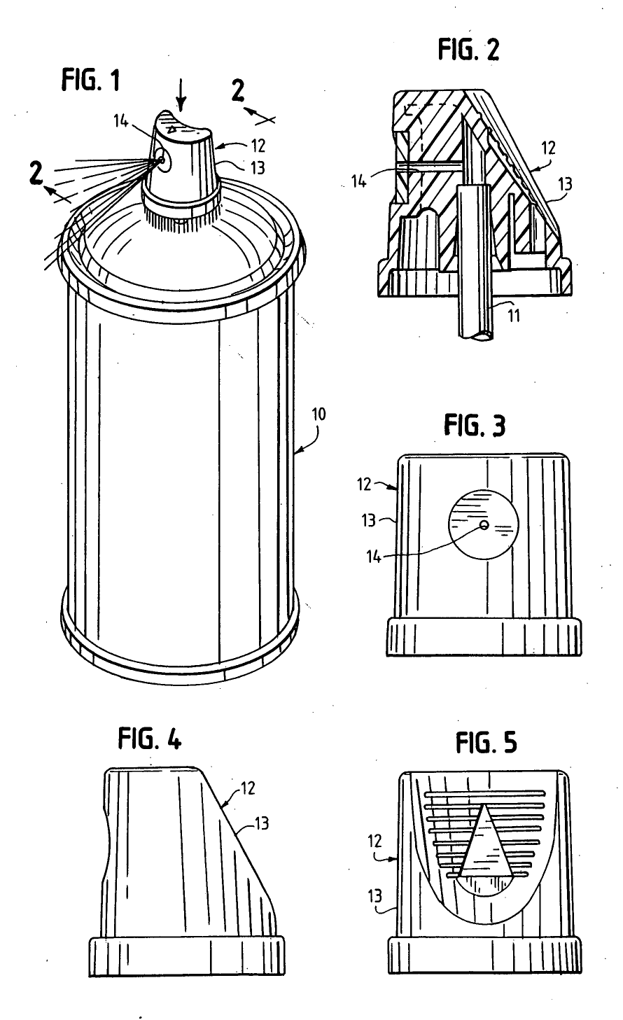

The preferred aerosol device of the invention is shown in the figures. In many respects, the device can be made to be conventional except for the composition of the aerosol composition within the device. Generally, the device includes a sealed container 10 (shown in FIG. 1) in which is disposed an aerosol composition prepared in accordance with the forgoing teachings. The container is normally pressurized with respect to ambient (1 atm) pressure. A valve 11 is in fluidic communication with the interior of the container and with a nozzle assembly 12 (shown in FIGS. 1-5), the nozzle assembly comprising a housing 13 which carries a nozzle 14. By manually actuating the valve, a user may dispense at least a portion of the contents of the pressurized container through the nozzle 14. The valve may be actuated by manually pressing on the housing 13. The valve may be designed as a metering valve, i.e., a valve that meters a predetermined amount of contents upon actuation. Preferably, however, the valve is an unmetered valve. One suitable valve is sold by Seaquist under product designation XT-91. The device may be made from any suitable components and via any suitable manufacturing techniques. For instance, various components of the device may be obtained commercially. The container may be filled by charging the container with the aerosol composition using any suitable techniques, which techniques will be known to persons of ordinary skill in the art. The final aerosol composition may not be prepared until after the propellant is charged into the aerosol device.

The aerosol composition may be sprayed onto any suitable feed or other nutritive product or nutritive source. Typical feeds include hay or corn derived feeds, but such feeds as dried fermentation residue, alfalfa, cottonseed, barley meal, soybean meal, corn meal, rice hulls, mineral salts, vitamins, silages, beet pulp, citrus pulp, fish meal, oats, rice bran, milo, sesame meal, milk and the like are also suitable. Other ingredients in the animal feed may include soybean meal, corn oil, ground corn, barley, mineral mixtures such as vermiculite or diatomaceous earth, corn gluten meal, corn distillers solubles or soy flour. The sweetened nutritive source may be fed to any animal, such as a mammal or non-mammal, and it is contemplated that the device will be useful for feeding to horses, dogs, cattle and other ruminants, pigs, and possibly birds and other animals. It is contemplated that the composition may be applied to human food products, such as pastries and ice cream.

The following examples are provided to illustrate the present invention, but should not be construed as limiting the invention in scope.

### EXAMPLE 1

The following licorice and molasses flavored spray was prepared:

| | |
|---|---|
| Sugar cane molasses | 25% |
| Glycerol 99.5% USP | 23% |
| CENTROL 3FSB | 10% |
| Reverse osmosis treated water | 22% |
| NEOBEE M-20 | 4.5% |
| Anise flavoring | 0.5% |
| A-70 | 15% |

NEOBEE M-20 is a C₈-C₁₀ fatty acid ester of propylene glycol. CENTROL 3FSB is a soy lecithin.

The composition was charged into an aerosol can equipped with a valve and nozzle, the nozzle being integral with a valve actuator. The valve and actuator had the following parameters:

| | Valve |
|---|---|
| Valve Number | 0300015015 |
| | Seaquist XT-91 .016 |
| | XT-150 .025 Yellow |
| Supplier | Seaquist |
| Valve Type | XT-91 |
| Stem Orifice | 0.016 Toggle |
| Stem Gasket | ES 0.051 BUNA P |
| | Code: 151 |
| Cup | XT Standard T-Seal, |
| | LAM, EPON Top, |
| | Dimpled, 1625, 10 LB |
| | Minimum Dip Tube |
| | Retention |
| Spring | .023 SS |
| Body Orifice | ES .062 |
| Seat | Standard Seat .025 |
| | Shoulder |
| Vapor Tap | None |
| Tubing ID | .122 |
| Dip Tube | 6 8/16 in. |

Actuator (Button-on-filling)

| | |
|---|---|
| Actuator Style | XT150 ES Solid Pattern |
| | Yellow 1043581P |
| Actuator Orifice | .025 Gentlemist RED |
| Size | RTC 15858 Treated |
| Supplier | 2704-03451-25 |
| Actuator | |
| Number | |

### EXAMPLE 2

A molasses flavored aerosol composition was prepared according to the following formulation:

| | |
|---|---|
| Molasses | 25% |
| Glycerol | 23% |
| 3FSB | 10% |
| Water | 22.5% |
| M-20 | 4.5% |
| A-70 | 15% |

The composition was charged into an aerosol can equipped with a valve and nozzle.

### EXAMPLE 3

An apple and molasses flavored aerosol composition was prepared according to the following formulation:

| | |
|---|---|
| Molasses | 25% |
| Glycerol | 22.5% |
| 3FSB | 10% |
| Water | 20% |
| M-20 | 4.5% |
| Apple flavoring | 3% |
| A-70 | 15% |

The composition was charged into an aerosol can equipped with a valve and nozzle.

### EXAMPLE 4

A caramel and molasses flavored composition was prepared according to the following formulation:

| | |
|---|---|
| Molasses | 25% |
| Glycerol | 22.5% |
| 3FSB | 10% |
| Water | 20% |
| M-20 | 4.5% |
| Caramel flavoring | 3% |
| A-70 | 15% |

The composition was charged into an aerosol can equipped with a valve and nozzle.

### EXAMPLE 5

The composition of Example 1 is discharged onto a horse feed, and the horse feed is fed to a horse.

It is thus seen that the present invention provides an aerosol device that is suitable for spraying molasses.

While the invention has been described with respect to specific examples including presently preferred modes of carrying out the invention, those skilled in the art will appreciate that there are numerous variations and permutations of the above described systems and techniques.

All references cited herein are hereby incorporated by reference in their entireties.

All methods described herein can be performed in any suitable order unless otherwise indicated herein or otherwise clearly contradicted by context. The use of any and all examples and exemplary language provided herein is intended merely to better illuminate the invention and does not pose a limitation on the scope of the invention. No language in the specification should be construed as indicating that any non-claimed element is essential to the practice of the invention.

Preferred embodiments of this invention are described herein, including the best mode known to the inventors for carrying out the invention. Variations of those preferred embodiments may become apparent to those of ordinary skill in the art upon reading the foregoing description. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An aerosol composition comprising:
water;
at least one organic aerosol propellant;
molasses components, said molasses components including at least one sugar, said sugar being selected from the group consisting of mono-, di-, and tri-, glycerides and mixtures thereof, and including molasses components that are insoluble in water and in the organic propellant; and
a surfactant, said molasses components and said water being present in an aqueous phase in said composition, said surfactant being effective to provide a viscosity for said aqueous phase that is sufficiently low to permit substantially uniform aerosol dispensing of said composition through a nozzle, said sugar being present in an amount effective to provide detectable sweetness in the residue of said composition after said composition has been dispensed onto a surface.

2. A composition according to claim 1, further comprising at least one C₃-C₅ polyol, said C₃-C₅ polyol being present in an amount effective to inhibit crystallization of said sugar in said composition.

3. A composition according to claim 2, said C₃-C₅ polyol being selected from the group consisting of propylene glycol and glycerol.

4. A composition according to claim 1, said composition containing an anti-agglomeration agent effective to inhibit agglomeration of said insoluble molasses compositions.

5. A composition according to claim 1, said surfactant being selected from a group consisting of the capric and caprylic acid esters of C₂-C₅ alcohols.

6. A composition according to claim 5, said surfactant comprising a mixture of capric and caprylic acid esters of propylene glycol.

7. A composition according to claim 4, said anti-agglomeration agent comprising lecithin.

8. A composition according to claim 7, said lecithin comprising soy lecithin.

9. A composition according to claim 1, said molasses components being components selected from the group consisting of beet and cane molasses components.

10. A composition according to claim 1, said composition includes a sugar stabilizer selected from the group consisting of propylene glycol and glycerol; said surfactant being selected from the group consisting of capric and caprylic acid esters of C₂-C₅ alcohols; said composition including an anti-agglomeration agent in an amount effective to prevent agglomeration of said insoluble molasses components.

11. A composition according to claim 10, said surfactant being selected from the group consisting of capric and caprylic acid esters of propylene glycol and mixtures thereof, said anti-agglomeration agent comprising soy lecithin.

12. An aerosol device comprising a sealed container containing the composition of claim 1, said device including an actuator valve, said actuator valve being in fluidic communication with said pressurized container and with a nozzle, said nozzle including an orifice through which the contents of said container may be dispensed upon actuation of said valve.

13. A method for dispensing a composition, the method including:
providing the aerosol device of claim 12; and
dispensing from said device at least a portion of the contents of said container.

14. A method according to claim 13, said aerosol composition being dispensed onto a nutritive animal source.

15. A method according to claim 14, said nutritive source comprising a human food product.

16. A method for feeding a non-human animal, the method comprising providing an aerosol device, said aerosol device comprising a sealed container and an actuator valve, said actuator valve being in fluidic communication with said container and with a nozzle, said nozzle including an orifice through which the contents of said container may be dispensed upon actuation of said valve, said container including an aerosol composition that includes water, at least one organic aerosol propellant; and at least one sugar, said sugar being selected from the group consisting of mono-, di-, and tri-, glycerides and mixtures thereof,
dispensing at least a portion of the contents of said aerosol device onto a nutritive source thereby providing a sweetened nutritive source; and
feeding said nutritive source to an animal.

17. A method according to claim 16, said composition comprising molasses solids.

18. A method according to claim 16, said sugar comprising a mixture of fructose and glucose.
